(19) United States
(12) Patent Application Publication
(10) Pub. No.: US 2013/0136520 A1
(43) Pub. Date: May 30, 2013

(54) IMAGE FORMING APPARATUS, IMAGE FORMING SYSTEM, CONTROLLING METHOD OF IMAGE FORMING APPARATUS, AND STORAGE MEDIUM

(71) Applicant: CANON KABUSHIKI KAISHA, Tokyo (JP)

(72) Inventor: Kanako Kaneda, Kamakura-shi (JP)

(73) Assignee: CANON KABUSHIKI KAISHA, Tokyo (JP)

(21) Appl. No.: 13/669,542

(22) Filed: Nov. 6, 2012

(30) Foreign Application Priority Data
Nov. 30, 2011 (JP) 2011-262270

(51) Int. Cl. B41J 11/66

(52) U.S. Cl. 400/621

(57) ABSTRACT

In an image forming apparatus for executing a cutting process, an area where a mark should be added to an outer circumferential side of a sheet from a cutting position which is set to a sheet is set. Print data in which a mark image has been added to print information which is input is formed in accordance with the setting to the mark-adding area. After the print data was printed, the printed sheets are bookbinding-bundled and, subsequently, a predetermined area is cut from a sheet sheaf in accordance with a cutting position.

### BACKGROUND OF THE INVENTION

1. Field of the Invention

The present invention relates to an image forming apparatus, an image forming system, a controlling method of the image forming apparatus, and a storage medium of storing a program to execute the controlling method.

2. Description of the Related Art

In the related arts, in image forming apparatuses such as a copying apparatus and the like, there has been proposed an image forming apparatus in which by connecting a post-processing apparatus for executing a post-process to a sheet to the image forming apparatus, a bookbinding process such as saddle stitch process for stitching a center portion of the paper or a middle-folding process for folding the center portion of the paper is executed. As for a paper sheaf which was bookbinding-processed, an edge portion is finished by a cutting process for cutting a circumferential blank portion.

In a bookbinding product completed by the bookbinding process, a fact that there are no problems such as misregistration in printing in a printing process, misregistration in bookbinding in the saddle stitch/middle-folding process, misregistration in cutting in the cutting process, and the like has to be confirmed. Ordinarily, in bookbinding inspecting work, an inspector grasps the bookbinding products one by one and confirms by a visual inspection.

However, in the bookbinding inspecting work by the confirmation based on the visual inspection, there is a fear of occurrence of such a problem that an inspecting precision is deteriorated due to a cause of an oversight of the inspector, such a problem that a working burden on the inspector increases because it is necessary to confirm all pages of many bookbinding products one by one every product, and the like.

To solve such problems, according to the technique disclosed in Japanese Patent Application Laid-Open No. 2001-047771, in order to detect missing pages and incorrect collating in the bookbinding product by the visual inspection confirmation, such a mark as to construct a specific figure is added to a top or bottom of the bookbinding product. The inspector confirms whether or not a shape of the mark added to the bookbinding product has correctly been formed, thereby enabling the missing pages to be easily and certainly detected.

However, the mark for inspecting the bookbinding product shown in Japanese Patent Application Laid-Open No. 2001-047771 is added along the outer circumference of the sheet. Therefore, even if the misregistration in cutting occurred at the time of the cutting process, since no mark is left on the sheet after the cutting process, there is such a problem that the user cannot be easily aware of the misregistration in cutting.

### SUMMARY OF THE INVENTION

The invention is made to solve the foregoing problem and it is an object of the invention to provide such a mechanism that the user can easily detect a misregistration in cutting which occurs at the time of a cutting process.

According to an aspect of the invention, there is provided an image forming apparatus comprising: an obtaining unit configured to obtain image data which is printed onto a sheet; a first setting unit configured to set whether or not a cutting process for cutting the sheet is executed; and a printing unit configured to execute the printing on the basis of the image data in the case where it is set by the first setting unit that the cutting process is executed and print a mark to an outer circumferential side of the sheet on the basis of a cutting position, as a reference, where the cutting process is executed.

Further features of the present invention will become apparent from the following description of exemplary embodiments with reference to the attached drawings.

### BRIEF DESCRIPTION OF THE DRAWINGS

FIG. 1 is a diagram illustrating a construction of an image forming system.

FIG. 2 is a block diagram illustrating a control construction of an image forming apparatus illustrated in FIG. 1.

FIG. 3 is a plan view illustrating an operation display apparatus illustrated in FIG. 1.

FIG. 4 is a cross sectional view illustrating a construction of a finisher illustrated in FIG. 1.

FIG. 5 is a block diagram illustrating a construction of a finisher controlling unit.

FIGS. 6A and 6B are cross sectional views illustrating a construction of a trimmer illustrated in FIG. 1.

FIGS. 7A and 7B are diagrams for describing a cutting process.

FIG. 8 is a block diagram for describing a trimmer controlling unit illustrated in FIG. 1.

FIGS. 9A and 9B are cross sectional views illustrating the construction of the finisher illustrated in FIG. 1.

FIGS. 10A and 10B are cross sectional views illustrating the construction of the finisher illustrated in FIG. 1.

FIGS. 11A, 11B, 11C, and 11D are cross sectional views illustrating the construction of the trimmer illustrated in FIG. 1.

FIG. 12 is a diagram for describing a bookbinding process and the cutting process.

FIGS. 13A, 13B, 13C, and 13D are diagrams illustrating UI display screens which are displayed to the operation display apparatus illustrated in FIG. 1.

FIGS. 14A, 14B, and 14C are diagrams illustrating UI display screens which are displayed to the operation display apparatus illustrated in FIG. 1.

FIG. 15 is a diagram for describing a cutting area.

FIG. 16 is a diagram for describing missing pages including a misregistration in bookbinding and a misregistration in cutting.

FIG. 17 is a flowchart for describing a controlling method of the image forming apparatus.

FIGS. 18A and 18B are diagrams illustrating a setting method of a mark area and the set mark area.

FIGS. 19A and 19B diagrams illustrating a setting method of a mark area and the set mark area.

FIG. 20 is a diagram illustrating a mark area which is printed.

### DESCRIPTION OF THE EMBODIMENTS

Preferred embodiments of the present invention will now be described in detail in accordance with the accompanying drawings.

### First Embodiment

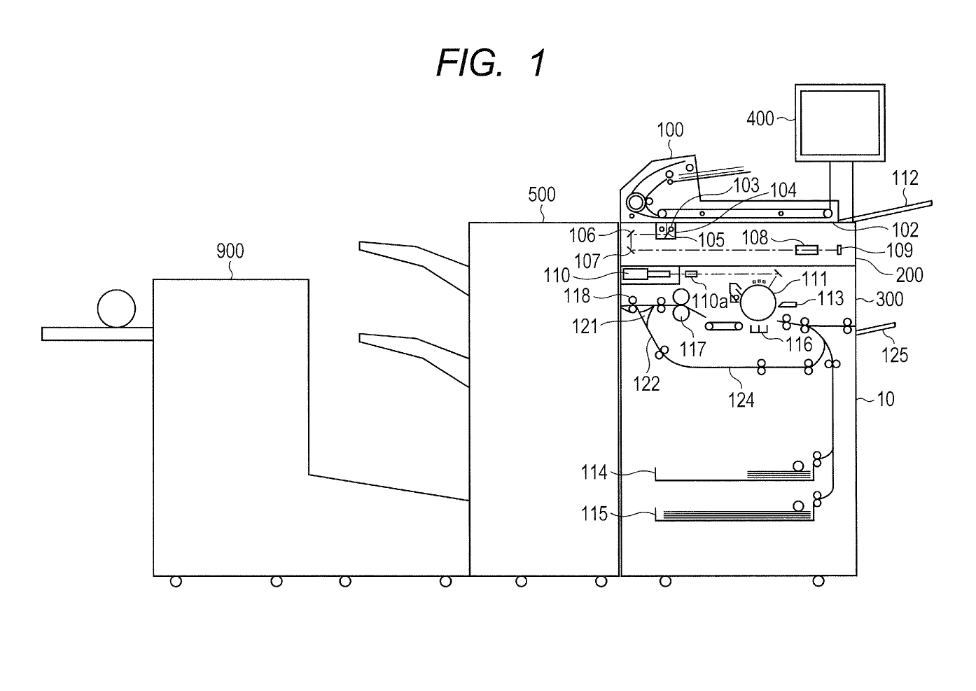

FIG. 1 is a diagram illustrating a construction of an image forming system to which an image forming apparatus showing the first embodiment of the invention is applied. The image forming system shown in the example is constructed by an image forming apparatus 10, a finisher 500, and a trimmer 900. The image forming apparatus 10 has an image reader 200 for reading an image of an original, a printer 300, an operation display apparatus 400, and a controller (not shown) for controlling the whole image forming system. In the embodiment, a bookbinding process and a cutting process will be described in detail by using an example of an image forming apparatus having such a cutting unit (trimmer) that sheets which are carried are bookbinding-bundled by a bookbinding unit for bookbinding them and, thereafter, the cutting process is executed to a sheet sheaf. Therefore, the invention can be applied even to an image forming apparatus in which the bookbinding path and the cutting path are different as shown in the embodiment. That is, the invention can be applied even to an image forming apparatus in which the bookbinding process and the cutting process are executed by different units. After the printed sheets were bookbinding-bundled, the trimmer cuts a predetermined area from the sheet sheaf in accordance with the cutting position. Details will be described hereinafter.

In FIG. 1, a document feeder 100 is mounted on the image reader 200. The document feeder 100 sequentially feeds sheets of an original set on an original tray in a face-up state one by one from the top page in the left direction in the diagram. Further, the document feeder 100 feeds the original from the left on a platen glass 102 through a curved path, carries to the right through a panning reading position, and thereafter, ejects toward an external paper discharge tray 112.

When the original passes through the panning reading position on the platen glass 102 from the left toward the right, an image of the original is read by a scanner unit 104 held at a position corresponding to the panning reading position. This reading method is a method which is generally called an original-panning reading. Specifically speaking, when the original passes through the panning reading position, a reading surface of the original is irradiated by light of a lamp 103 in the scanner unit 104. The reflection light from the original is guided to a lens 108 through mirrors 105, 106, and 107. The light which passed through the lens 108 is focused onto an image pickup surface of an image sensor 109.

By carrying the original so as to pass through the panning reading position from the left to the right as mentioned above, an original reading scan in which the direction which perpendicularly crosses the carrying direction of the original is set to the main scanning direction and the carrying direction is set to the sub-scanning direction is performed.

That is, when the original passes through the panning reading position, by carrying the original in the sub-scanning direction while reading the original image every line in the main scanning direction by the image sensor 109, the whole original image is read. The image which was optically read is converted into image data by the image sensor 109 and output. The image data which was output from the image sensor 109 is subjected to a predetermined process by an image signal controlling unit 202, which will be described hereinafter, and subsequently, the image data is input as a video signal to an exposure controlling unit 110 in the printer 300.

It is also possible to construct in such a manner that the original is carried onto the platen glass 102 by the document feeder 100 and stopped at a predetermined position, thereafter, the original is read by scanning the scanner unit 104 from the left side to the right side in this state. This reading method is what is called an original-fixed reading. In the case of reading the original without using the document feeder 100, the user lifts up the document feeder 100 and puts the original onto the platen glass 102. By scanning the scanner unit 104 from the left side to the right side, the original is read. That is, in the case of reading the original without using the document feeder 100, the original-fixed reading is performed.

The exposure controlling unit 110 in the printer 300 modulates a laser beam in accordance with a video signal which was input and outputs. While the laser beam is scanned by a polygon mirror 110a, it is irradiated onto a photosensitive drum 111. An electrostatic latent image according to the scanned laser beam is formed onto the photosensitive drum 111. In the case of the original-fixed reading, the exposure controlling unit 110 emits the laser beam so that a correct image (image instead of a mirror image) is formed.

The electrostatic latent image on the photosensitive drum 111 is visualized as a developer image by a developer which is supplied from a developing unit 113. At the timing synchronized with the start of the irradiation of the laser beam, paper is fed from each cassette 114 or 115, a manual paper feeding unit 125, or a two-sided carrying path 124. The paper is carried between the photosensitive drum 111 and a transferring unit 116.

The developer image formed on the photosensitive drum 111 is transferred onto the paper fed by the transferring unit 116. The paper onto which the developer image has been transferred is carried to a fixing unit 117. The fixing unit 117 heats and presses the paper, thereby fixing the developer image onto the paper. The paper which passed through the fixing unit 117 is ejected from the printer 300 to the outside (finisher 500) through a flapper 121 and an ejecting roller 118.

In the case of ejecting the paper in a (face-down) state where the image forming surface faces down, the paper which passed through the fixing unit 117 is temporarily guided into a reversing path 122 by the switching operation of the flapper 121. After a rear edge of the paper passed through the flapper 121, the paper is switched back and ejected from the printer 300 by the ejecting roller 118.

Such a paper discharge state is called a reversal paper discharge hereinafter. The reversal paper discharge is performed in the case of sequentially forming images from the head page, for example, in the case where the images which were read by using the document feeder 100 are formed, where the images which were output from a computer are formed, or the like, so that the order of the paper derived after the paper discharge becomes the correct page order.

In the case where hard paper such as OHP sheets or the like is fed from the manual paper feeding unit 125 and images are formed onto the paper, the paper is not guided to the reversing path 122 but is ejected by the ejecting roller 118 in a (face-up) state where the image forming surface faces up.

Further, if a two-sided recording mode of forming images onto both surfaces of the paper has been set, the paper is temporarily discharged by the ejecting roller 118 and, thereafter, switched back. Then, the paper is guided to the reversing path 122 by the switching operation of the flapper 121 and, thereafter, carried to the two-sided carrying path 124. Subsequently, such control that the paper guided to the two-sided carrying path 124 is fed again between the photosensitive drum 111 and the transferring unit 116 at the foregoing timing is performed.

The paper ejected from the printer 300 is conveyed to the finisher 500. The finisher 500 executes various kinds of processes such as a stapling process and the like. Further, the trimmer 900 executes the cutting process to an edge portion of the paper to which a saddle stitch, middle-folding, or the like has been performed by the finisher 500.

(System Construction)

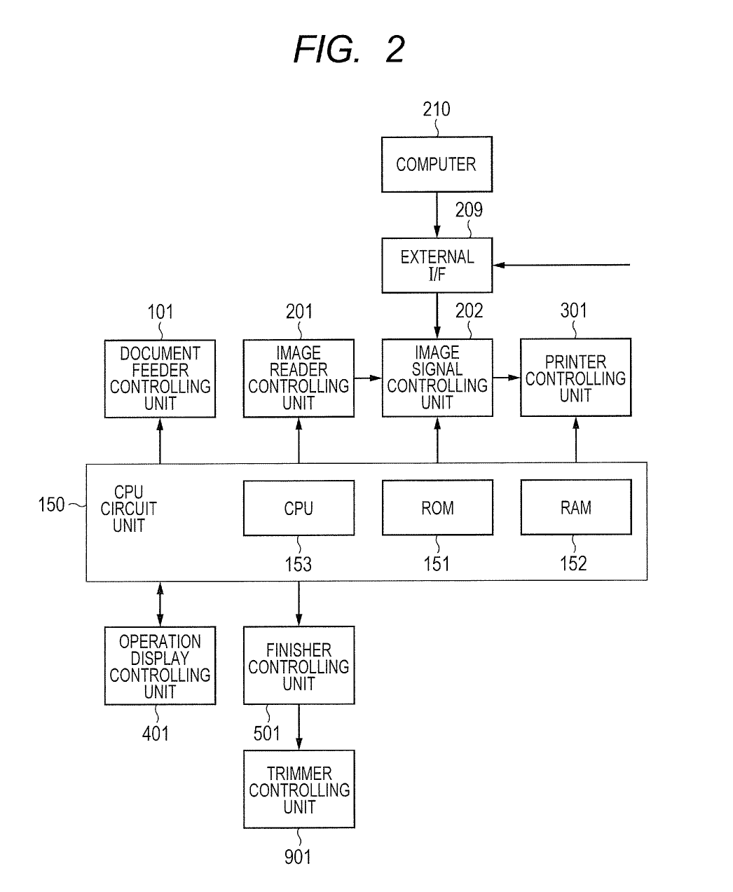

FIG. 2 is a block diagram illustrating a control construction of the image forming apparatus 10 illustrated in FIG. 1. In this example, the controller is constructed mainly by a CPU circuit unit 150.

In FIG. 2, a document feeder controlling unit 101, an image reader controlling unit 201, the image signal controlling unit 202, a printer controlling unit 301, an operation display controlling unit 401, and a finisher controlling unit 501 are connected to the CPU circuit unit 150. An external interface (I/F) 209 connected to a computer 210 is connected to the image signal controlling unit 202. A trimmer controlling unit 901 is connected to the finisher controlling unit 501.

The CPU circuit unit 150 has therein a CPU 153, a ROM 151, and a RAM 152. The CPU 153 executes a control program stored in the ROM 151, thereby integratedly controlling the respective units 101, 201, 202, 209, 301, 401, and 501. The RAM 152 is used as a work area for an arithmetic operating process accompanied with the control such as a process for temporarily holding control data or the like.

The document feeder controlling unit 101 drives the document feeder 100 in response to an instruction from the CPU circuit unit 150. The image reader controlling unit 201 drives the scanner unit 104, image sensor 109, and the like and transfers the analog image signal which was output from the image sensor 109 to the image signal controlling unit 202.

The image signal controlling unit 202 converts an analog image signal from the image sensor 109 into a digital signal, thereafter, executes various kinds of processes thereto, converts the digital signal into a video signal, and outputs to the printer controlling unit 301. The image signal controlling unit 202 executes various kinds of processes to a digital image signal which was input from the computer 210 through the external I/F 209, converts the digital image signal into a video signal and outputs to the printer controlling unit 301. The processing operation which is executed by the image signal controlling unit 202 is controlled by the CPU circuit unit 150.

The printer controlling unit 301 drives the exposure controlling unit 110 on the basis of the video signal which was input. The finisher controlling unit 501 is mounted in the finisher 500, transmits and receives information to/from the CPU circuit unit 150, and drives the whole finisher.

The trimmer controlling unit 901 is mounted in the trimmer 900, transmits and receives information to/from the finisher controlling unit 501, and drives the whole trimmer.

The operation display controlling unit 401 transmits and receives information to/from the operation display apparatus 400 and the CPU circuit unit 150. The operation display apparatus 400 has a plurality of keys for setting various kinds of functions regarding the image creation, a displaying unit for displaying information showing a setting state, and the like. The operation display controlling unit 401 outputs a key signal corresponding to the operation of each key to the CPU circuit unit 150 and allows the corresponding information to be displayed to the displaying unit in accordance with a signal from the CPU circuit unit 150.

(Operation Display Apparatus)

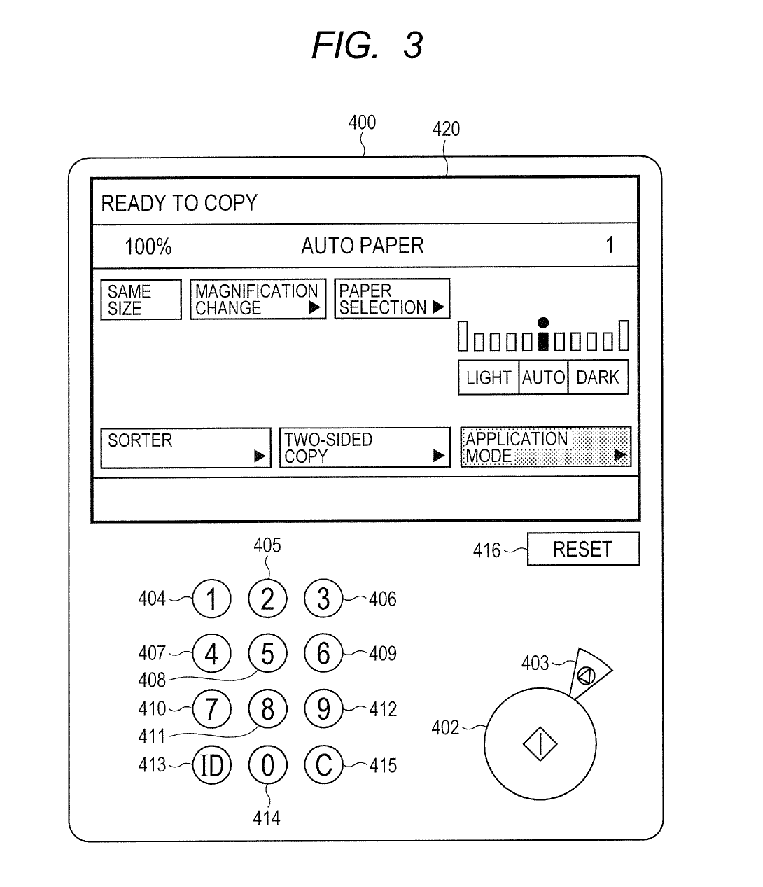

FIG. 3 is a plan view illustrating the operation display apparatus 400 illustrated in FIG. 1.

In FIG. 3, the operation display apparatus 400 has a start key 402 to start the image forming operation and a stop key 403 to interrupt the image forming operation. Further, a ten-key 404 to 412 and 414 for performing a numerical setting or the like, an ID key 413, a clear key 415, a reset key 416, and the like are arranged in the operation display apparatus 400. A liquid crystal displaying (LCD) unit 420 formed with a touch panel is arranged in an upper portion of the operation display apparatus 400. Software keys are formed on a display screen of the LCD unit 420.

The image forming apparatus of the embodiment has post-processing modes such as non-sorting mode, sorting mode, staple sorting mode (stapling mode), bookbinding mode, and the like. Such a post-processing mode is set by the inputting operation from the operation display apparatus 400. For example, in the case of setting the post-processing mode, if “sorter” serving as a software key is selected on an initial display screen (refer to FIG. 3), a menu selecting display screen is displayed to the LCD unit 420 and the post-processing mode is set by using the menu selecting display screen.

(Finisher)

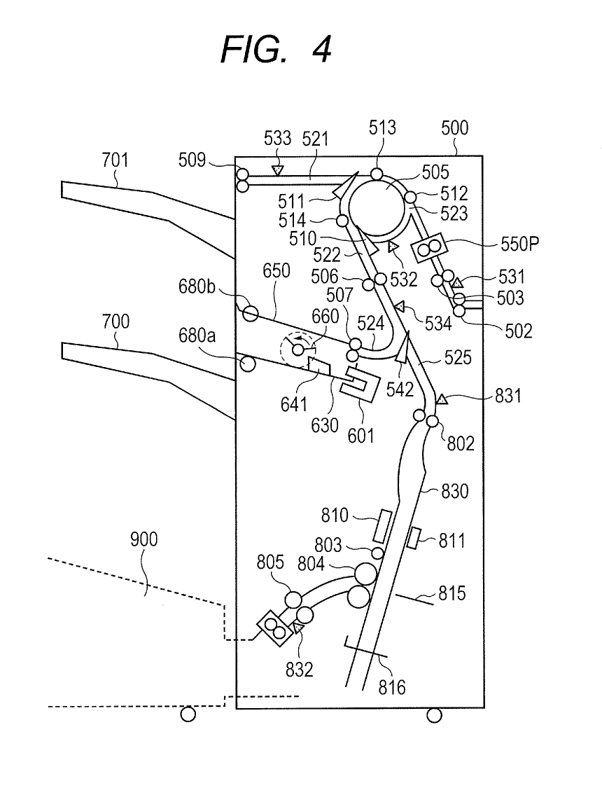

FIG. 4 is a cross sectional view illustrating a construction of the finisher 500 illustrated in FIG. 1.

In FIG. 4, the finisher 500 sequentially fetches the paper ejected from the image forming apparatus 10 and executes a process for aligning a plurality of sheets of fetched paper and bundling into one paper sheaf and a stapling process for stapling a rear edge of the bundled paper sheaf. Further, the finisher 500 executes a process for punching a portion near the rear edge of the fetched paper. The finisher 500 also executes various kinds of paper post-processes such as sorting process, non-sorting process, bookbinding process, and the like.

In the finisher 500, the paper ejected from the image forming apparatus 10 is fetched into the apparatus by an inlet roller pair 502. The paper fetched into the apparatus is sent toward a buffer roller 505 through a carrying roller pair 503. An inlet sensor 531 is provided on the way of a carrying path between the inlet roller pair 502 and the carrying roller pair 503. A punching unit 550P is provided on the way of a carrying path between the carrying roller pair 503 and the buffer roller 505. The punching unit 550P operates in accordance with the necessity and punches the portion near the rear edge of the carried paper.

The buffer roller 505 is a roller which can laminate a predetermined number of sheets of paper which were sent through the carrying roller pair 503 and wind them around an outer circumference of the buffer roller. Depressing rollers 512, 513, and 514 are provided around the outer circumference of the buffer roller 505. During the rotation of the roller, the paper is wound by each of the depressing rollers 512, 513, and 514. The wound paper is carried in the rotating direction of the buffer roller 505.

A change-over flapper 511 is arranged between the depressing rollers 513 and 514. A change-over flapper 510 is arranged on a downstream side of the depressing roller 514. The change-over flapper 511 is a flapper for peeling off the paper wound around the buffer roller 505 from the buffer roller 505 and guiding to a non-sorting path 521 or a sorting path 522. The change-over flapper 510 is a flapper for peeling off the paper wound around the buffer roller 505 from the buffer roller 505 and guiding to the sorting path 522 or is a flapper for guiding the paper wound around the buffer roller 505 to a buffer path 523 in a wound state.

When the paper wound around the buffer roller 505 is guided to the non-sorting path 521, the change-over flapper 511 operates, the wound paper is peeled off from the buffer roller 505 and guided to the non-sorting path 521. The paper guided to the non-sorting path 521 is discharged onto a sample tray 701 through an ejecting roller pair 509. A paper discharge sensor 533 is provided on the way of the non-sorting path 521 and detects a paper discharge.

When the paper wound around the buffer roller 505 is guided to the buffer path 523, both of the change-over flappers 510 and 511 do not operate, so that the paper is sent to the buffer path 523 in a state where the paper has been wound around the buffer roller 505. A path sensor 532 is provided on the way of the buffer path 523 and detects the paper on the buffer path 523.

When the paper wound around the buffer roller 505 is guided to the sorting path 522, the change-over flapper 511 does not operate but the change-over flapper 510 operates, and the wound paper is peeled off from the buffer roller 505 and guided to the sorting path 522.

A change-over flapper 542 to guide the paper to a sort ejecting path 524 or a bookbinding path 525 is arranged on the downstream of the sorting path 522. The paper guided to the sort ejecting path 524 is stacked onto an intermediate tray (hereinbelow, referred to as a processing tray) 630 through a carrying roller pair 507.

An aligning process by an aligning member 641 provided on each of this side and the interior side, a stapling process, or the like is executed to the paper stacked in a sheaf shape onto the processing tray 630 in accordance with the necessity. After that, the paper is ejected onto a stacking tray 700 by ejecting rollers 680a and 680b.

The ejecting roller 680b is supported to an oscillation guide 650. The oscillation guide 650 oscillates by an oscillation motor (not shown) so that the ejecting roller 680b is come into contact with the top paper on the processing tray 630. When the ejecting roller 680b is in a state where it is in contact with the top paper on the processing tray 630, the ejecting roller 680b can eject the paper sheaf on the processing tray 630 toward the stacking tray 700 in cooperation with the ejecting roller 680a.

The stapling process is executed by a stapler 601. The stapler 601 is constructed so as to be movable along an outer circumference of the processing tray 630 and can staple the paper sheaf stacked on the processing tray 630 at the end position (rear edge) of the paper in the paper carrying direction (the left direction in the diagram).

The paper guided to the bookbinding path 525 is carried to a bookbinding intermediate tray (hereinbelow, referred to as a bookbinding processing tray) 830 through a carrying roller pair 802. A bookbinding inlet sensor 831 is provided on the way of the bookbinding path 525. An intermediate roller 803 and a movable paper positioning member 816 are provided for the bookbinding processing tray 830. An anvil 811 is provided at a position which faces a pair of staplers 810. The staplers 810 and the anvil 811 cooperate and execute the stapling process to the paper sheaf enclosed in the bookbinding processing tray 830.

A folding roller pair 804 is provided on the downstream side of the staplers 810. A bumping member 815 is provided at a position opposite to the folding roller pair 804. By bumping the bumping member 815 toward the paper sheaf enclosed in the bookbinding processing tray 830, the paper sheaf enclosed in a bundle shape in the bookbinding processing tray 830 is pushed out between the folding roller pair 804. Thus, a middle-folding is performed to the center of the paper. In the embodiment, up to three sheets of paper can be middle-folded. The folding roller pair 804 folds the paper sheaf and carries the folded paper sheaf to the downstream.

The folded paper sheaf is sent to the trimmer 900 by the paper discharge roller pair. A paper discharge sensor 832 is provided on the downstream side of the folding roller pair 804.

(Finisher Controlling Unit)

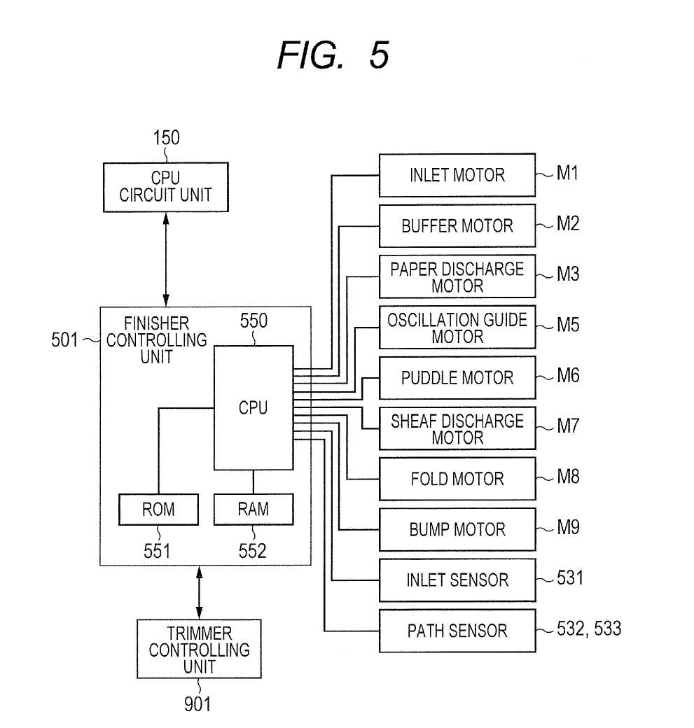

FIG. 5 is a block diagram illustrating a construction of the finisher controlling unit 501 which is mounted in the finisher 500 illustrated in FIG. 4 and is used to control the whole finisher 500. In this example, the finisher controlling unit 501 is constructed by a CPU 550, a ROM 551, a RAM 552, and the like. Various kinds of motors M1 to M3 and M5 to M9, the inlet sensor 531, the path sensor 532, the paper discharge sensor 533, and the like are connected to the CPU 550.

In FIG. 5, through a communication IC (not shown), the finisher controlling unit 501 communicates with the CPU circuit unit 150 provided in the image forming apparatus 10 and performs a data exchange. In response to an instruction from the CPU circuit unit 150, the finisher controlling unit 501 executes various kinds of programs stored in the ROM 551 and drives the finisher 500. Independent of the image forming apparatus, the finisher controlling unit 501 communicates with the trimmer controlling unit 901 through the communication IC (not shown).

(Trimmer)

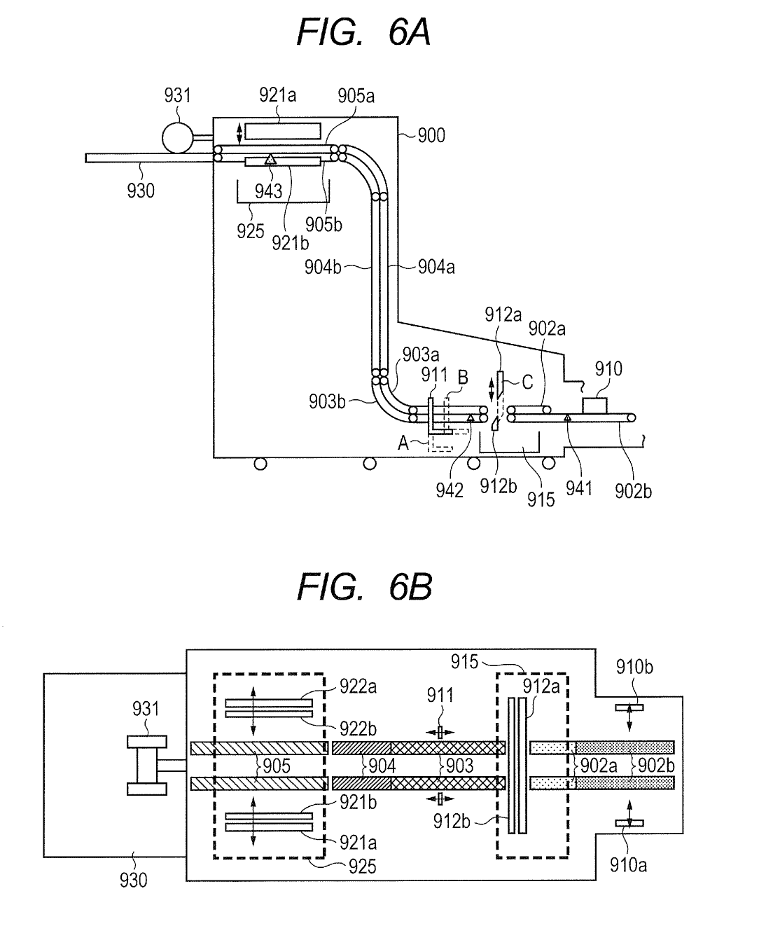

FIGS. 6A and 6B are diagrams illustrating a construction of the trimmer 900 illustrated in FIG. 1. FIG. 6A is a vertical sectional view. FIG. 6B is a plan view.

In FIGS. 6A and 6B, the trimmer 900 receives the paper which was middle-folded by the bookbinding processing unit of the finisher 500 on a center reference basis. At this time, the paper dropped from a paper discharge roller pair 805 in the finisher 500 is sandwiched between a this-side aligning member 910a and an interior aligning member 910b of an aligning member 910 provided in a receiving unit and is allowed to approach the center of the carrying path. After that, the paper is carried to the downstream by a pair of carrying belts 902 (902a, 902b). Thus, a paper misregistration which occurs when the paper is carried into the finisher 500 is corrected.

Carrying belt pairs 902 (902a, 902b), 903 (903a, 903b), 904 (904a, 904b), and 905 (905a, 905b) are provided at positions of an equal distance from the center of the carrying path, respectively. The paper is carried to the downstream in a state where it is sandwiched between the pair of upper and lower carrying belts.

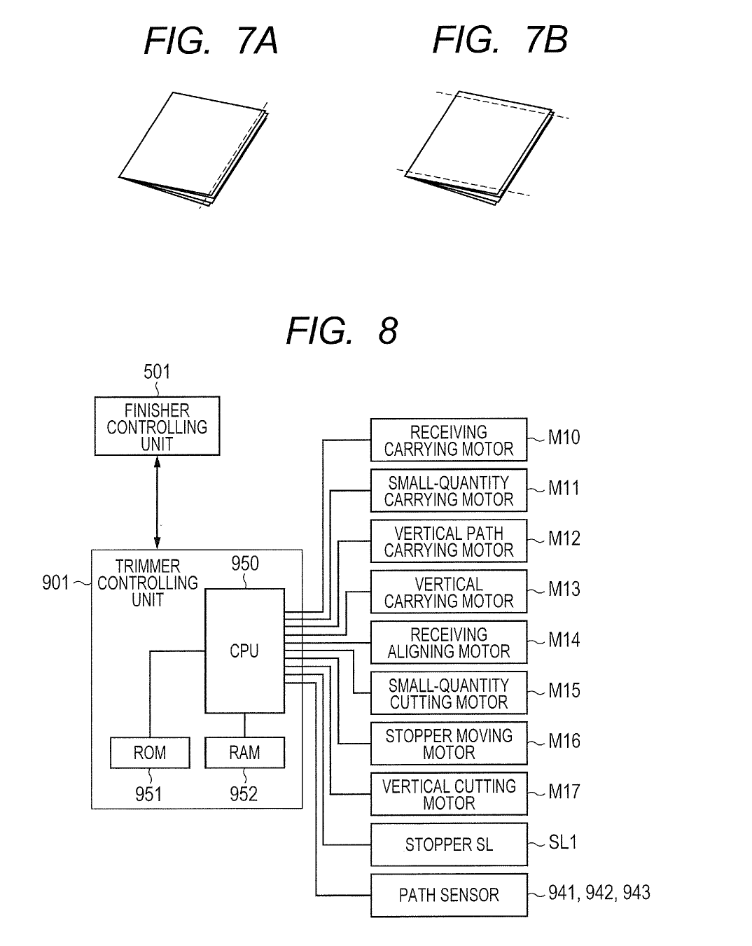

A mechanism for cutting an edge portion on the side opposite to a middle-folding edge portion (hereinbelow, referred to as a small-quantity cutting) serving as a downstream side of the paper carrying path is provided between the carrying belts 902 and 903. FIG. 7A is a diagram illustrating the small-quantity cutting. A front edge of the paper which is carried is bumped to a small-quantity stopper 911, so that the paper is stopped (refer to FIGS. 6A and 6B). To a small-quantity cutting lower blade 912b which sandwiches the stopped paper and is fixed, a small-quantity cutting upper blade 912a which faces the lower blade 912b and can ascend and descend falls, so that the small-quantity cutting is performed (refer to a position shown by a broken line in FIG. 8).

The small-quantity stopper 911 can freely sink or exit toward the carrying belts 903 in order to carry the paper without performing the small-quantity cutting or in order to carry the paper after the cutting to the downstream (in FIG. 6A, A denotes a sunk state). The small-quantity stopper 911 is movable in the carrying direction in order to switch a paper stopping position according to a paper size or in order to switch the paper stopping position so as to adjust the cutting position (in FIG. 6A, B denotes a moved state).

Cut paper chips are enclosed into a small-quantity chip box 915. Generally, the small-quantity cutting upper blade 912a is on standby at the ascending position so as not to obstruct the conveyance of the paper (in FIG. 6A, C denotes a standby state).

A mechanism for cutting an edge portion which perpendicularly crosses the middle-folding edge portion (hereinbelow, referred to as a vertical cutting) is provided for the carrying belts 905 arranged on the downstream side of the small-quantity cutting portion. FIG. 7B illustrates the vertical cutting. Fixed vertical cutting lower blades 921b and 922b are provided on this side and the interior side of the carrying belts 905. To the vertical cutting lower blades 921b and 922b, vertical cutting upper blades 921a and 922a fall, respectively, so that the vertical cutting of the paper stopped by the carrying belts 905 is performed (refer to a position shown by a broken line in FIG. 7B) in a manner similar to the small-quantity cutting.

The vertical cutting blades, 921a, 921b, 922a, and 922b are movable in the this-side and interior directions and are moved in accordance with the paper size and the adjustment of the cutting position. The chips cut by the vertical cutting unit are enclosed into a vertical chip box 925. In the case where the vertical cutting is not performed, the paper is carried to the downstream by the carrying belts 905 without being stopped.

The paper which passed through the carrying belts 905 is ejected onto a stacking tray 930. At this time, a large-conveyance roller 931 provided over the stacking tray 930 is driven to move the ejected paper on the stacking tray 930. The paper which has already been stacked on the stacking tray 930 is also moved to the upstream and downstream sides of the tray, thereby preventing the paper from remaining at a paper discharge port of the carrying belts 905.

(Construction of Trimmer Controlling Unit)

FIG. 8 is a block diagram for illustrating a construction of the trimmer controlling unit 901 which is mounted in the trimmer 900 illustrated in FIG. 1 and controls the whole trimmer 900. In this example, the trimmer controlling unit 901 is constructed by a CPU 950, a ROM 951, a RAM 952, and the like. Various kinds of motors M10 to M17, a stopper solenoid (SL) SL1, path sensors 941, 942, and 943, and the like are connected to the CPU 950.

Through the communication IC (not shown), the trimmer controlling unit 901 communicates with the finisher controlling unit 501 provided in the finisher 500 and performs a data exchange. In response to an instruction from the finisher controlling unit 501, the trimmer controlling unit 901 executes various kinds of programs stored in the ROM 951 and controls the trimmer 900.

The carrying belts 902a and 902b are connected to the receiving carrying motor M10. The carrying belts 902a and 902b are driven by the receiving carrying motor M10. The carrying belts 903a and 903b are connected to the small-quantity carrying motor M11. The carrying belts 903a and 903b are driven by the small-quantity carrying motor M11. The carrying belts 904a and 904b are connected to the vertical path carrying motor M12. The carrying belts 904a and 904b are driven by the vertical path carrying motor M12. The carrying belts 905a and 905b are connected to the vertical carrying motor M13. The carrying belts 905a and 905b are driven by the vertical carrying motor M13. The motors M10 to M13 are constructed by stepping motors.

The this-side aligning member 910a and the interior aligning member 910b are connected to the receiving aligning motor M14. The this-side aligning member 910a and the interior aligning member 910b are driven by the receiving aligning motor M14, are moved in the center direction by a forward rotation, and are symmetrically moved in the outside direction by a reverse rotation.

The small-quantity cutting upper blade 912a is connected to the small-quantity cutting motor M15. The small-quantity cutting upper blade 912a is elevated up or down by the forward or reverse rotation of the small-quantity cutting motor M15. The small-quantity cutting motor M15 is constructed by a DC motor because a motor load fluctuates by the number of sheets of paper to be cut or a thickness of paper.

The small-quantity stopper 911 is connected to the stopper moving motor M16. A position of the small-quantity stopper 911 is controlled by the stopper moving motor M16 and the stopper 911 is moved in the carrying direction. The stopper moving motor M16 is constructed by a stepping motor. An elevation of the small-quantity stopper 911 is driven by the stopper solenoid SL1.

The vertical cutting upper blade 921a is connected to the vertical cutting motor M17. In a manner similar to the small-quantity cutting upper blade 912a, the vertical cutting upper blade 921a is elevated up or down by the forward or reverse rotation of the vertical cutting motor M17. The vertical cutting motor M17 is constructed by a DC motor.

(Operation in the Bookbinding Mode)

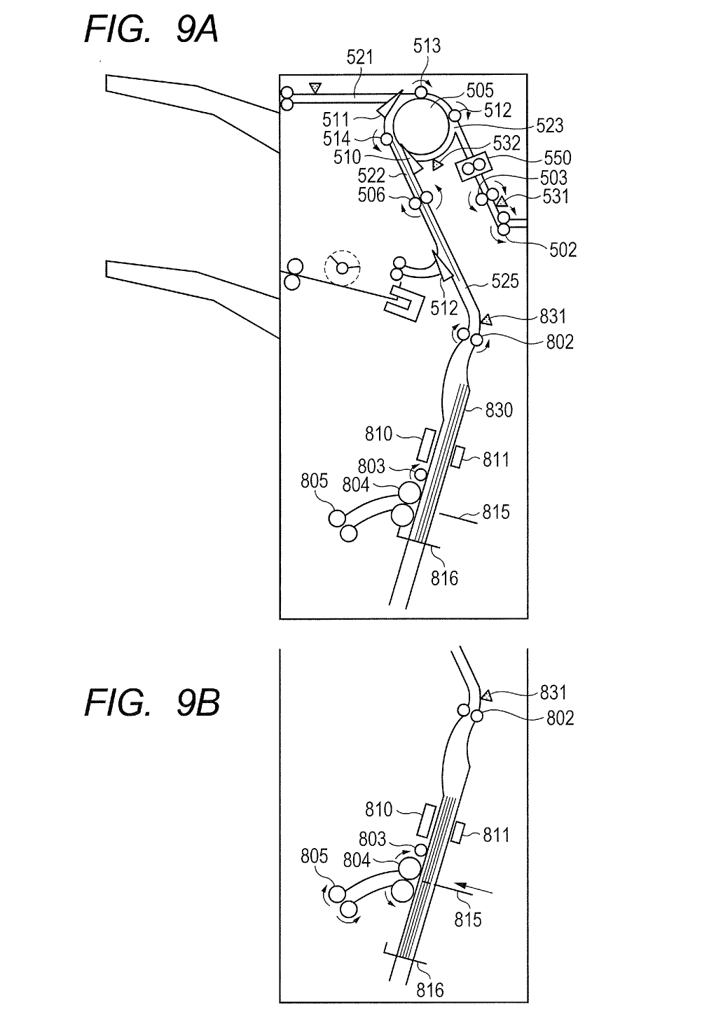

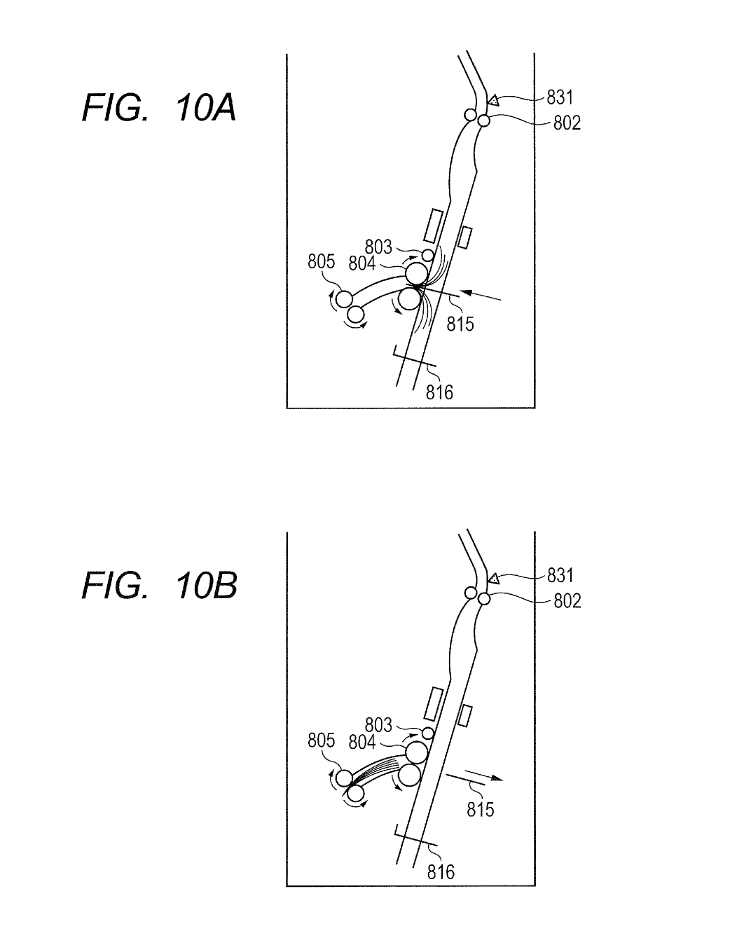

Subsequently, a flow of the paper in the bookbinding mode will be described with reference to FIGS. 9A, 9B, 10A, and 10B. In FIGS. 9A and 9B, the same component elements as those in FIG. 4 are designated by the same reference numerals.

As illustrated in FIG. 9A, when the bookbinding mode is designated, the inlet roller pair 502, carrying roller pair 503, and buffer roller 505 are rotated and the paper P ejected from the image forming apparatus 10 is fetched into the finisher 500 and carried. The change-over flappers 510 and 511 and the depressing roller 512 are stopped at the positions illustrated in the diagram. The paper P is guided from the sorting path 522 to the bookbinding path 525 and is enclosed onto the bookbinding processing tray 830 by the carrying roller pair 802. The intermediate roller 803 is rotated and the paper is carried until the front edge of the paper enclosed on the bookbinding processing tray 830 is come into contact with the paper positioning member 816. At this time, the paper positioning member 816 exists at a position where the stapling process is executed to the center of the enclosed paper sheaf by the staplers 810.

When the front edge of the paper has reached the paper positioning member and the conveyance has been stopped, the aligning members (not shown) operate in the paper carrying direction and the vertical direction and the paper is aligned. When a predetermined number of sheets of paper have been aligned and enclosed, the stapling process is executed to the center of the paper sheaf (hereinbelow, referred to as a saddle stitch) by the staplers 810 as mentioned above.

As illustrated in FIGS. 9B and 10A, the paper positioning member 816 is descended to a position where the stapling position (center of the paper) reaches the center position of the folding roller pair 804. The folding roller pair 804 and the paper discharge roller pair are rotated and, at the same time, the bumping member 815 is projected so that the paper sheaf is protruded between the folding roller pair 804. As illustrated in FIG. 10B, while the paper sheaf is folded by the folding roller pair 804, it is carried to the downstream and is ejected to the trimmer 900 by the paper discharge roller pair.

In the case of the bookbinding mode in which the saddle stitch is not performed, in a manner similar to the case of performing the saddle stitch as mentioned above, after the paper was temporarily enclosed at the position where the stapling process is executed to the center of the paper sheaf, the stapling process is not executed but the paper positioning member 816 is descended until the position where the center of the paper reaches the center position of the folding roller pair 804. After that, the bumping member 815 is projected so that the paper sheaf is protruded between the folding roller pair 804. While the paper sheaf is folded by the folding roller pair 804, it is carried to the downstream.

(Operation in the Cutting Mode)

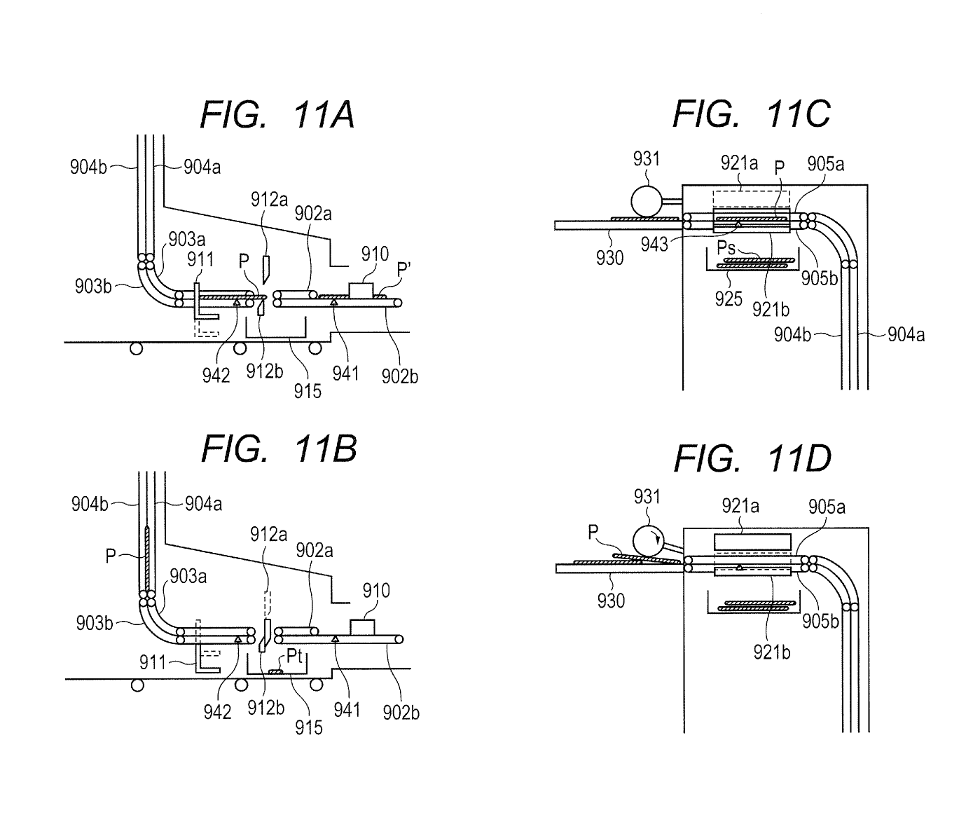

Subsequently, a flow of the paper in the cutting mode will be described with reference to FIGS. 11A, 11B, 11C, and 11D. As illustrated in FIG. 11A, when a paper sheaf P′ which was saddle-stitched and middle-folded in the foregoing bookbinding mode is started to be ejected from the paper discharge roller pair 805 in the finisher 500, the carrying belts 902a and 902b are rotated. After the path sensor 941 on the carrying belt 902b detected a front edge of the paper sheaf P′, at a point of time when the paper sheaf P′ has been carried by a predetermined distance and a rear edge of the paper sheaf P′ has dropped onto the carrying belt 902b, the driving of the carrying belts 902a and 902b is stopped. At this time, since the front edge of the paper does not reach the carrying belt 902a, the paper sheaf P′ is not sandwiched between the carrying members but is in a free state. The aligning members 910a and 910b operate in the paper carrying direction and the vertical direction and the aligning operation to make the center of the carrying path and the center of the paper sheaf coincide is executed. When the aligning operation is finished, the carrying belts 902a, 902b, 903a, and 903b are driven again and the paper is carried to the downstream.

In the case of performing the small-quantity cutting, the small-quantity stopper is ascended from a standby position shown by a broken line to a position where the stopper is projected to the carrying path as shown by a solid line. Further, the stopper is moved to the position corresponding to the cutting quantity in the carrying direction. After the path sensor 942 detected the front edge of the paper sheaf P which had been carried to the downstream by the carrying belts 902a, 902b, 903a, and 903b, the paper sheaf P is carried by a predetermined distance. Then, the carrying belts 902a, 902b, 903a, and 903b are stopped, the front edge of the paper is come into contact with the small-quantity stopper 911 and enters a state where it is sandwiched between the carrying belts 903a and 903b. At this time, the rear edge of the paper sheaf P is in a state where it came out of the carrying belts 902.

As illustrated in FIG. 11B, the small-quantity cutting upper blade 912a descends, the rear edge side of the paper sheaf P is cut, and cut paper chips Pt drop due to the empty weight and are enclosed into the small-quantity chip box 915 provided in a lower portion of the cutting blade. When the cutting operation is finished, the small-quantity stopper 911 descends, the carrying path is opened, and the carrying belts 903a, 903b, 904a, and 904b and the carrying belts 905a and 905b illustrated in FIG. 11C are rotated, thereby further carrying the paper sheaf P to the downstream. In the following description, there is a case where reference characters a and b added to the reference numerals showing the carrying belts are omitted and an explanation is made.

In the case where the small-quantity cutting is not performed, after the aligning operation was performed by the aligning member 910, a standby state where the small-quantity stopper 911 descended is held and the carrying belts 902, 903, 904, and 905 are rotated in this state, thereby carrying the paper sheaf P to the downstream without being temporarily stopped in the small-quantity cutting unit.

Subsequently, as illustrated in FIG. 11C, in the case of performing the vertical cutting to the paper sheaf P carried to the downstream by the carrying belts 904a and 904b, after the path sensor 943 detected the front edge of the paper, the paper sheaf P is carried by a predetermined distance. Then, the driving of the carrying belts 905 is stopped. While the paper sheaf P is carried by the carrying belts 904, the vertical cutting blades 921a and 921b have been moved to the positions corresponding to the cutting quantity. The vertical cutting upper blade 921a descends and a vertical edge portion of the paper sheaf P is cut. Cut paper chips Ps drop and are enclosed into the vertical chip box 925. After that, when the vertical cutting upper blade 921a ascends, the carrying belts 905a and 905b are driven and the paper sheaf P is ejected onto the stacking tray 930 as illustrated in FIG. 11D. Before the front edge of the paper sheaf P reaches the large-conveyance roller 931, the large-conveyance roller 931 on a paper discharge tray has been rotated, thereby moving the paper sheaf P onto the stacking tray 930.

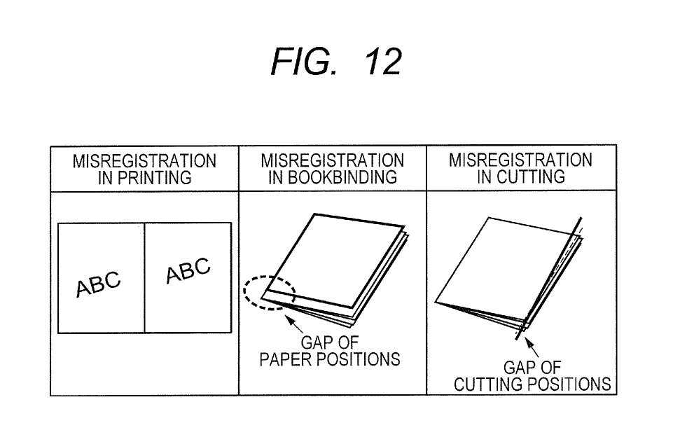

FIG. 12 illustrates kinds of misregistration which can occur in the image forming apparatus having each mode of the bookbinding process as mentioned above. There is a case where the misregistration in the printing process as illustrated on the left side in FIG. 12 occurs by the electrostatic latent image on the photosensitive drum 111, the developer image in the developing unit 113, or a defective transfer to the paper in the transferring unit 116. In the case where an expansion or contraction of the paper occurs at the time of heating and pressing the paper in the fixing unit 117, it also becomes a cause of the misregistration. There is a case where the misregistration in the bookbinding process as illustrated at a center of FIG. 12 occurs as shown in a portion surrounded by a broken line in the diagram because the paper sheaf is deviated in the saddle stitch process or the middle-folding process. Further, the misregistration in the cutting process as shown on the right side of FIG. 12 occurs because the paper sheaf is cut in a state where the paper sheaf itself has been deviated from the cutting position and set as shown by a solid line in the diagram. All of those misregistrations have to be detected by inspection since quality of a completed product of the bookbinding product is deteriorated.

(Setting of the Bookbinding Mode and the Cutting Mode)

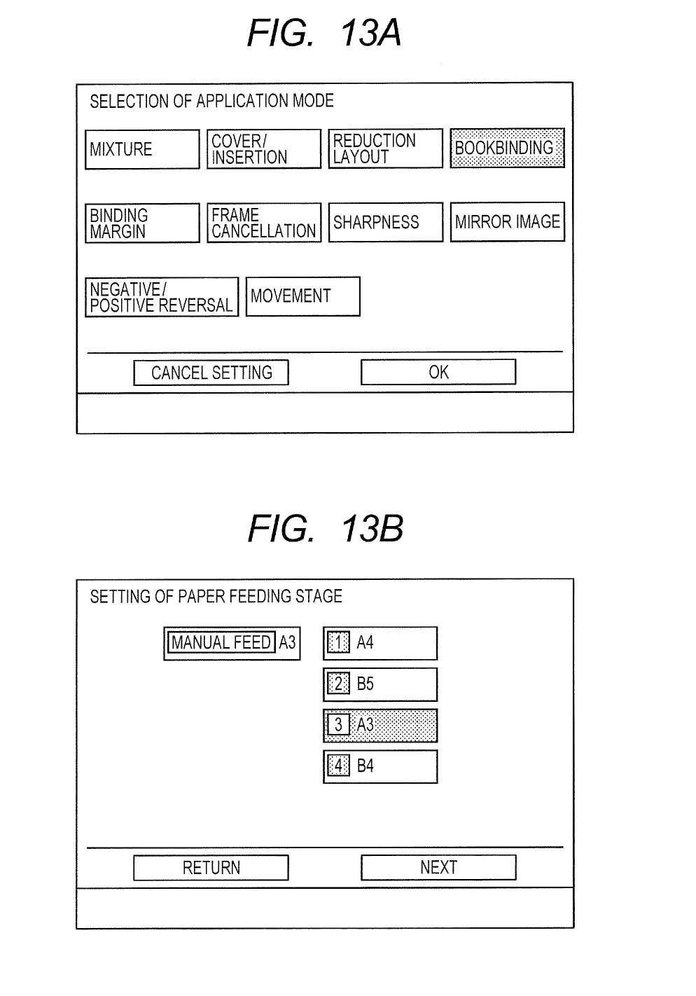

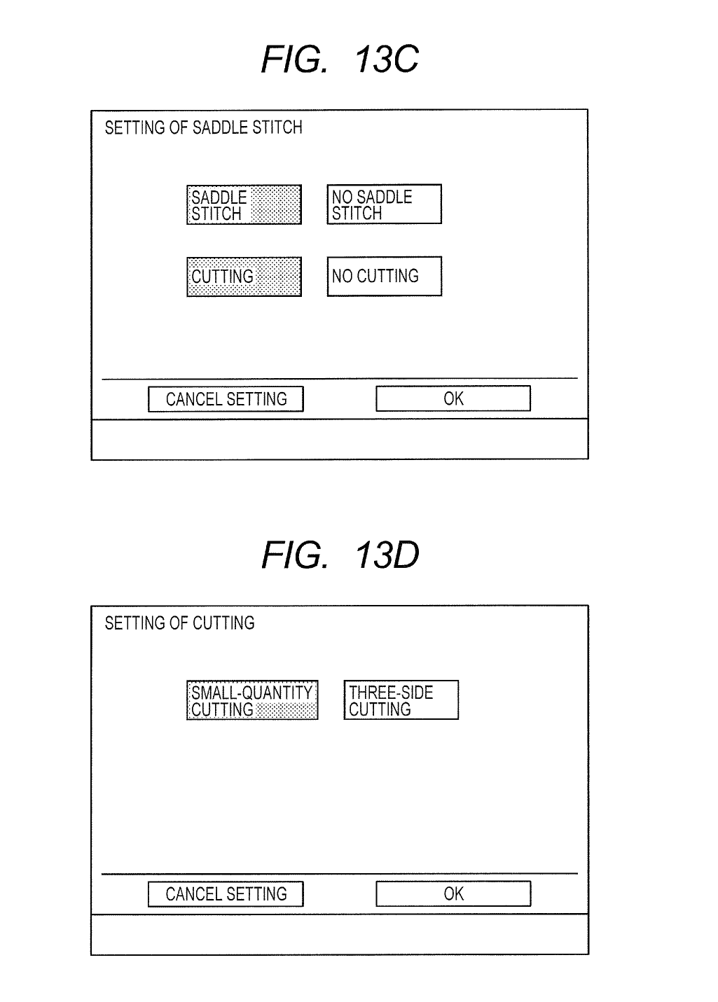

Subsequently, a flow for the setting of the bookbinding mode and the cutting mode will be described with reference to FIGS. 13A, 13B, 13C, and 13D.

When “application mode” serving as a software key is selected on an initial display screen illustrated in FIG. 3, the LCD unit 420 is switched to a display screen adapted to select various kinds of modes as illustrated in FIG. 13A. When “bookbinding” is selected here, as illustrated in FIG. 13B, keys which can select a cassette in which recording paper to be output has been enclosed are displayed. When the cassette in which the paper of the size which is used has been enclosed is selected and a software key of “next” is pressed, as illustrated in FIG. 13C, a display screen adapted to set a process to the bookbinding sheaf is displayed. When the bookbinding mode is selected, although at least the middle-folding is performed, the user can select whether or not the saddle stitch is performed. The user selects either “saddle stitch” or “no saddle stitch”. Further, independent of the saddle stitch, the user can select whether or not the cutting is performed. When “no cutting” is selected and an “OK” key is pressed irrespective of the contents of the setting about the saddle stitch, the setting is finished and the screen is returned to the initial display screen illustrated in FIG. 3. The apparatus enters a state where it is waited that the start key 402 is pressed and the operation is started.

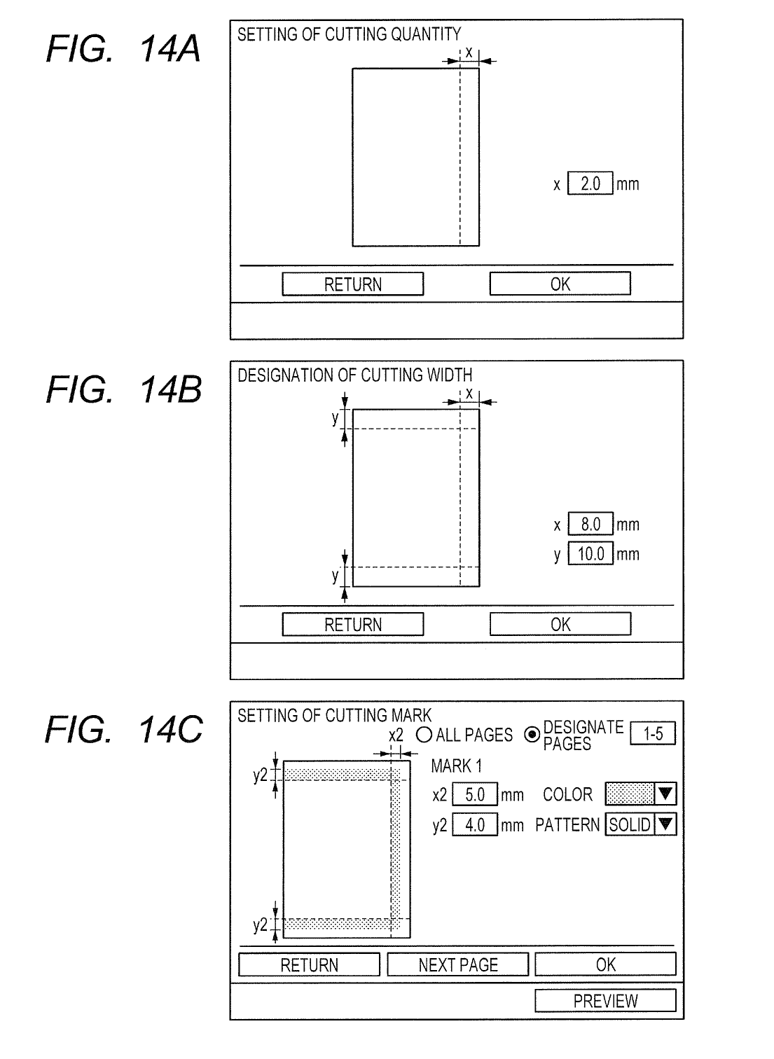

When “cutting” is selected and the “OK” key is pressed irrespective of the contents of the setting about the saddle stitch in FIG. 13C, a display screen adapted to set the cutting process is subsequently displayed (refer to FIG. 13D). Either a mode to perform only the small-quantity cutting or a mode to perform a three-side cutting for executing both of the small-quantity cutting and the vertical cutting is selected. When the small-quantity cutting is selected and the “OK” key is pressed, as illustrated in FIG. 14A, a display screen adapted to set a cutting length x from the edge portion of the paper is displayed and an arbitrary cutting quantity can be set from the ten-key of an operation displaying unit. If the three-side cutting is selected in FIG. 14A, as illustrated in FIG. 14B, a cutting quantity x on the small-quantity side and a cutting quantity y on the vertical side are input from the ten-key of the operation displaying unit in a manner similar to the case of the designation of the cutting quantity in the small-quantity cutting.

The set cutting quantities x and y are sent to the trimmer controlling unit 901 and are used for control of the positions of the small-quantity cutting blades 912a and 912b and the vertical cutting blades 921a, 921b, 922a, and 922b. At this time, in the case of the small-quantity cutting, the small-quantity stopper 911 is used as a reference in the small-quantity cutting and the position of the small-quantity cutting lower blade 912b to the cutting quantity x is unconditionally decided. In the case of the vertical cutting, the positions of the vertical cutting lower blades 921b and 922b are decided to a predetermined interval from the cutting quantity y.

When the “OK” key is pressed after the cutting quantities were input in FIG. 14A or FIG. 14B, the screen is subsequently switched to a display screen adapted to set a cutting mark as illustrated in FIG. 14C. FIG. 14C is a cutting mark setting display screen upon setting of the three-side cutting. In the setting display screen of FIG. 14C, the user designates values of x2 and y2. Thus, the cutting mark is added in a range of (x2, y2) on the immediate outside from the cutting position which is decided from the cutting quantities x and y set in the display screen of FIG. 14B.

Information of the cutting mark which was set here is transmitted to the image signal controlling unit 202 by the CPU circuit unit 150. The digital image signal is converted into the video signal and, thereafter, a print image to which a mark for confirming the inspecting bookbinding product by visual inspection has been added is formed in the printer controlling unit 301.

By this display screen, the user can select a color and a pattern of the mark which is painted in the cutting range. As for the pattern of the mark, besides a solid pattern which is fully painted, another pattern such as dots, lattice, or gradation can be selected. The solid painting is selected unless otherwise the user especially designates it.

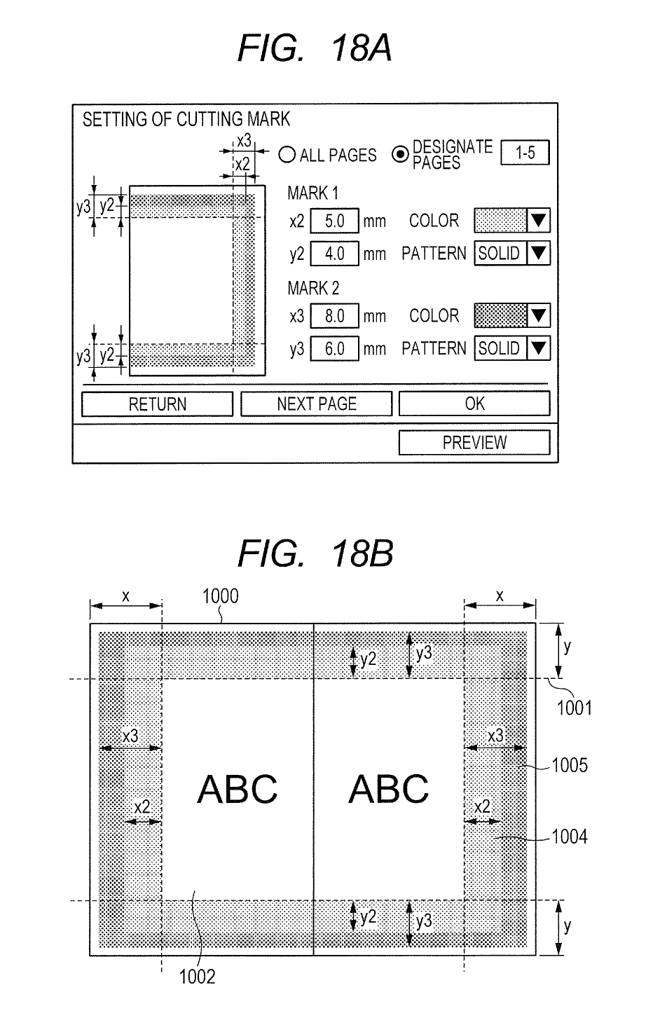

Further, the range, color, and pattern of the cutting marker may be set in accordance with a toner residual quantity of the image forming apparatus. Specifically speaking, if the toner residual quantity of the image forming apparatus is small, information of the toner residual quantity is displayed on a setting display screen of FIG. 18A and the display of each setting is limited so that the user can select only the range, color, and pattern of the cutting mark in which a toner consumption quantity can be suppressed. In accordance with the information of the toner residual quantity and the selectable settings which are displayed on the setting display screen, the user can select the range, color, and pattern which are set in consideration of the toner consumption quantity.

Upon setting of the addition of the cutting mark to the print image illustrated in FIG. 14C, a mode for adding the cutting mark on a page unit basis can be also set. In the case where the mode for adding the cutting mark every page is set, a “designate pages” button on the setting display screen of FIG. 14C is checked and the mode for adding the cutting mark in accordance with the page is set. In FIG. 14C, after the cutting mark in a certain page was set, when a “next page” key is pressed, a different cutting mark to another page can be also set. When a “preview” key is pressed, a preview of the print image to which the mark has been added is displayed to the LCD unit 420. When the “OK” key is pressed, the screen is returned to the initial display screen illustrated in FIG. 3. The apparatus enters a state where it is waited that the start key 402 is pressed and the operation is started.

Although the cutting mark setting display screen for the three-side cutting setting is illustrated in FIG. 14C, when the small-quantity cutting is set, since the screen is switched to the setting display screen only for the small-quantity cutting unit, the cutting mark for the small-quantity cutting can be also set.

It is desirable that such a cutting mark adding setting on a page unit basis is used in accordance with a feature of the pages included in the bookbinding product. For example, a mode in which such a color and a pattern that it can be easily confirmed by visual inspection are selected in accordance with a coloring of the page, a mode in which the cutting mark is not added to the pages such as a blank page or the like in which the detection of misregistration is unnecessary, or the like can be set.

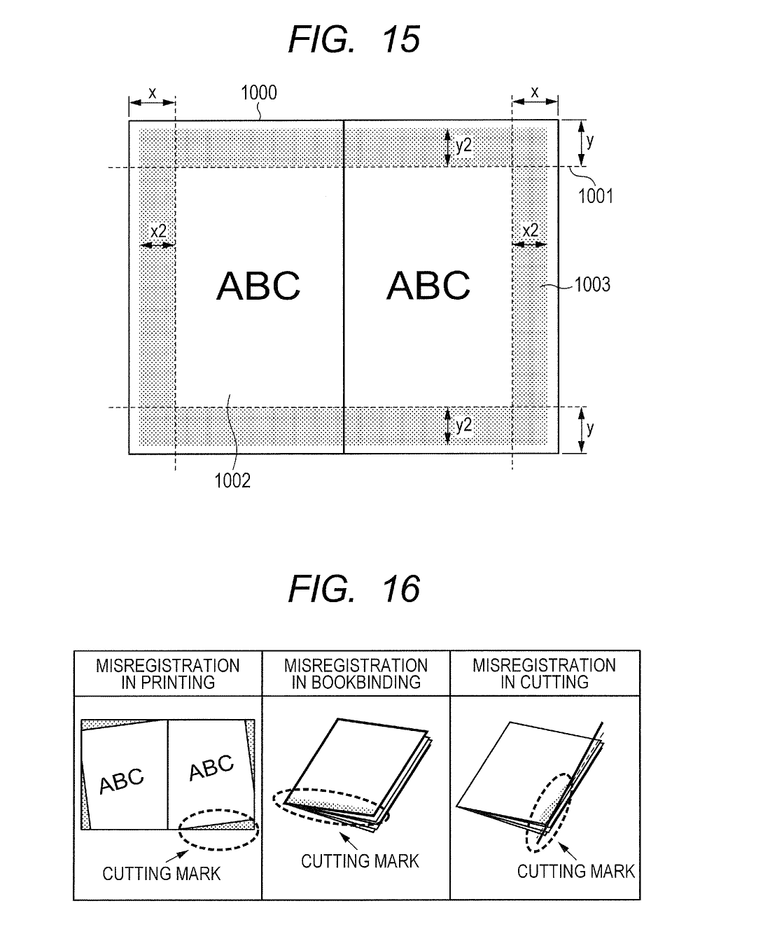

FIG. 15 is a diagram illustrating an example of a print image to which the cutting mark has been added by the image forming apparatus 10 illustrated in FIG. 1.

In FIG. 15, to paper 1000, a cutting position corresponding to the cutting quantities x and y set in the foregoing cutting mode is indicated by a broken line 1001. A range 1002 of the paper after the cutting is obtained for the cutting position. A cutting mark 1003 for detecting the misregistration of the bookbinding product is added to a range of (x2, y2) from the outside of the cutting position 1001 by the color and pattern which were set by the user.

FIG. 16 is a diagram illustrating an example of a finished product of the bookbinding product in the case where, to the print image to which the cutting mark has been added as illustrated in FIG. 15, a misregistration occurred in the image forming apparatus having each mode of the bookbinding process.

To the misregistration in the printing process, when the bookbinding product is spread-opened as illustrated on the left side of FIG. 16, a state where the cutting mark remains can be confirmed. As for the misregistration in the bookbinding process, the cutting mark can be confirmed by the paper which was bookbinding-processed so as to be deviated from the paper sheaf as illustrated in the center of FIG. 16. Further, even to the misregistration in the cutting process, the cutting mark remains by such an amount that the paper sheaf itself is deviated from the cutting position as illustrated on the right side of FIG. 16. That is, since the bookbinding product in which the cutting mark remains indicates that some misregistration has occurred, by merely confirming the presence or absence of the cutting mark by visual inspection, whether or not there is a defective bookbinding can be easily discriminated.

(Bookbinding Inspecting Flow)

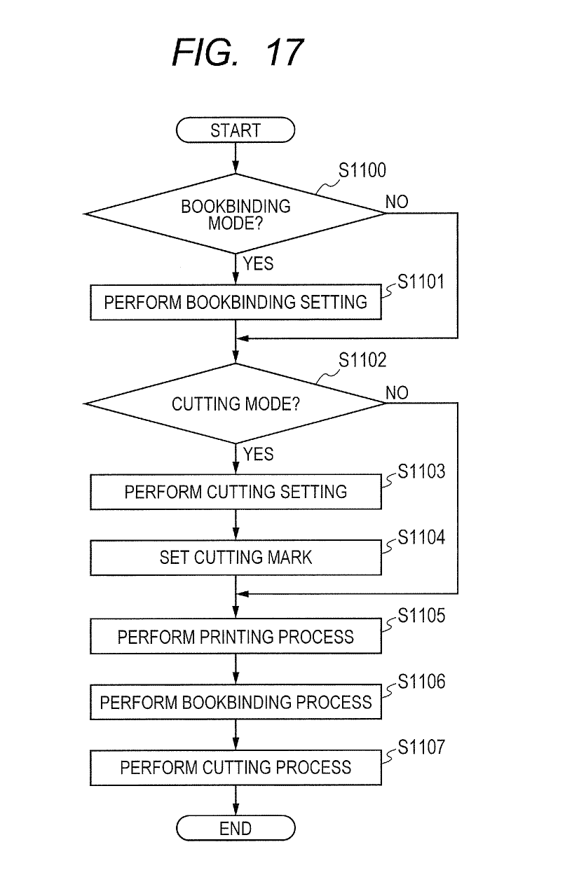

FIG. 17 is a flowchart for describing a controlling method of the image forming apparatus showing the embodiment. This example relates to the bookbinding process in the case of setting the mode of adding the cutting mark in the image forming apparatus. Each processing step is realized by a method whereby the CPU 153 illustrated in FIG. 2 loads the control program from the ROM 151 or the like into the RAM 152 and executes it. The CPU 153 communicates with the CPU for controlling each unit and executes the printing process, bookbinding process, and cutting process in accordance with the control program. The printing process in which an area to add the mark is set to the outer circumferential side of the sheet from the cutting position which is set to the sheet, print data in which the mark image has been added to print information which is input is formed in accordance with the setting to the mark area, and the print data including the mark image is printed will be described in detail hereinbelow.

Details regarding the bookbinding setting and the cutting setting are as described in FIGS. 13A to 13D and FIGS. 14A o 14C and the user makes such settings by operating a UI display screen which is displayed to the operation display apparatus 400. However, it is also possible to construct in such a manner that the UI display screen is transmitted to a PC or the like on the network and the user sets them by using a remote display screen.

First, in S1100, the CPU 153 discriminates whether or not the user has selected the bookbinding mode by using the operation display apparatus 400. If the CPU 153 determines that the user does not select the bookbinding mode, the bookbinding setting in S1100 is skipped and S1102 follows.

If the CPU 153 determines in S1100 that the bookbinding mode has been selected, the user selects the setting of the paper feed stage or the saddle stitch process as mentioned above.

Subsequently, in S1102, the CPU 153 discriminates whether or not the user has selected the cutting mode by using the operation display apparatus 400. If the CPU 153 determines that the cutting mode is not selected, the cutting setting in S1103 is skipped and S1105 follows.

If the CPU 153 determines in S1102 that the cutting mode has been selected, the user sets the small-quantity cutting or the three-side cutting and, thereafter, sets the cutting quantities as mentioned above. Subsequently, in S1104, the CPU 153 sets the cutting mark addition on the basis of the cutting method and the cutting quantities which were set in S1103. In this instance, the range of the cutting mark, the page to which the cutting mark is added, the color and pattern of the cutting mark, and the like are set.

Subsequently, in S1105, the CPU 153 forms the print data on the basis of the bookbinding processing setting in S1100 to S1104 and executes the printing process. At this time, if the cutting mark adding setting has been made in S1104, the printing process for adding the cutting mark to the print image data is executed.

Subsequently, in S1106, in response to the instruction from the CPU 153, on the basis of the bookbinding setting selected in S1101, the finisher controlling unit 501 executes the bookbinding process to the paper sheaf which was print-processed in S1105.

In S1107, in response to the instruction from the CPU 153, on the basis of the cutting setting selected and set in S1103 and S1104, the CPU of the trimmer controlling unit 901 executes the cutting process to the paper sheaf which was bookbinding-processed in S1106. After the bookbinding product was completed, the present processing routine is finished.

The bookbinding product completed by the above processing flow is sent to the inspecting work by the inspector. Unlike the inspection by the visual inspection confirmation in the related art, since the inspection target is the bookbinding product to which the cutting mark has been added, the inspector can detect the defective bookbinding by confirming by the visible inspection whether or not the cutting mark remains on the bookbinding product.

### Second Embodiment

The second embodiment of the invention will now be described with reference to the drawings.

Since a construction of an image forming system in the embodiment is similar to that of the first embodiment, the same component elements as those in the first embodiment are designated by the same reference numerals and their description is omitted and different operations will be described here.

FIGS. 18A and 18B are diagrams illustrating an example of a user interface display screen (UI display screen) displayed to the operation display apparatus 400 illustrated in FIG. 1. This example relates to a setting display screen of the cutting mark in the second embodiment.

In the setting display screen of FIG. 18A, the user designates values of x2, y2, x3, and y3 by using the operation display apparatus 400. Thus, the cutting mark is added in each of the ranges of (x2, y2) and (x3, y3) on the immediate outside from the cutting position which is decided from the cutting quantities x and y set in the UI display screen of FIG. 14B.

That is, the user can select the different colors and patterns of the different marks to the two ranges of the range of (x2, y2) on the immediate outside from the cutting position on the UI display screens illustrated in FIGS. 18A and 18B and the range of (x3, y3) on the further outside from the cutting position.

FIG. 18B is a diagram illustrating an example of the user interface display screen (UI display screen) displayed to the operation display apparatus 400 illustrated in FIG. 1. This example relates to a print image in which cutting marks have been added to the two ranges on the display screen illustrated in FIG. 18A. First, a first cutting mark 1004 is added to the range of (x2, y2) on the outside from the cutting position 1001 by the color and pattern which were set by the user. Further, a second cutting mark 1005 is added to the range of (x3, y3) from the cutting position 1001 on the outside of the first cutting mark by the color and pattern which were designated by the user.

By adding the marks 1 and 2 of the different colors and patterns on the inside and outside of the cutting position, respectively, the different marks can be set in accordance with a size (level) of the misregistration. Therefore, an inspecting level according to a favor of the user can be set.

For example, by adding the marker of the inconspicuous color to the range where the level of the misregistration is small, the user is allowed to discriminate whether or not such a misregistration can be permitted at the time of inspection. On the other hand, by adding the marker of the conspicuous color to the range where the level of the misregistration is large, the inspector can certainly detect the defective inspection.

### Third Embodiment

Subsequently, the third embodiment will be described with reference to the drawings. The operations different from those in the foregoing embodiments will be also described here.

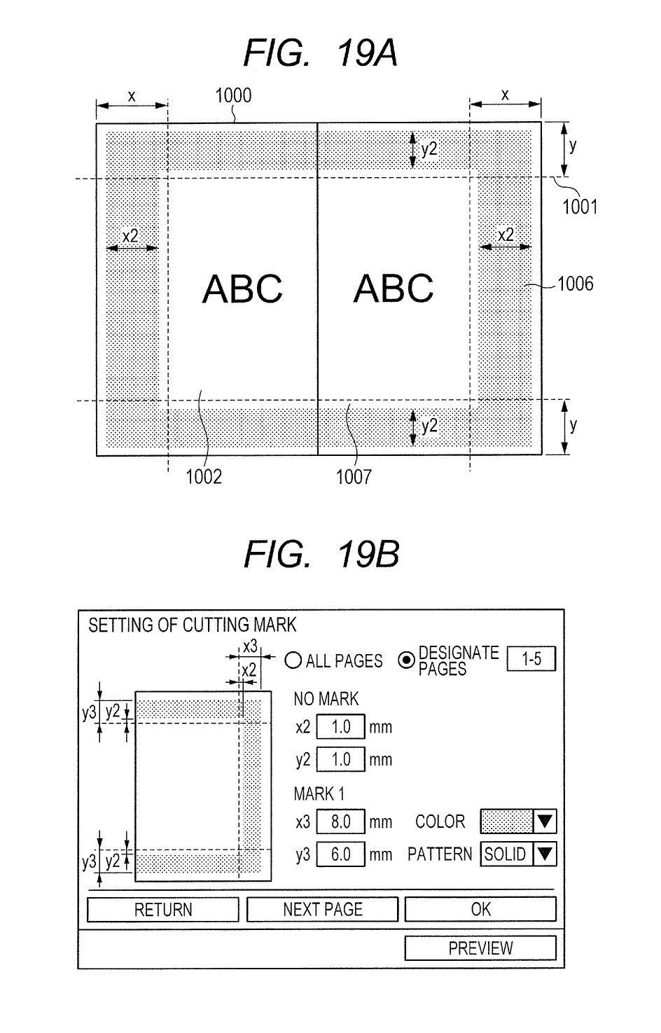

FIG. 19A is a diagram illustrating an example of a print image to which cutting marks have been added in the image forming apparatus showing the embodiment. Although the cutting mark has been added on the immediate outside from the cutting position 1001 in FIG. 15 shown in the first embodiment, in the third embodiment, the cutting mark is added from the position on the slightly outside from the cutting position 1001 as illustrated in FIG. 19A. This is because it is necessary to consider a permission range of the misregistration occurring in the bookbinding process.

That is, in the print image to which the cutting mark has been added in FIG. 19A, the cutting mark is not added to a misregistration permission range 1007 on the outside from the range 1002 of the paper after the cutting. The cutting mark is added to a range 1006 of (x2, y2) from such a range to the cutting position 1001.

The permission range 1007 to which the cutting mark is not added is a range for permitting an error of the position control of the small-quantity cutting blades 912a and 912b and the vertical cutting blades 921a, 921b, 922a, and 922b to the set cutting quantities. To such permission quantities of the position control of the cutting blades as mentioned above, it is desirable that no marker is added in the detection of the misregistration of the bookbinding inspection. Since such a permission range can be preliminarily used as an inherent value which the image forming apparatus has, by adding a misregistration quantity peculiar to an engine to the range designated by the setting display screen of FIG. 14C, the cutting mark including the permission range of the misregistration upon cutting as illustrated in FIG. 19A can be added. In the embodiment, it is constructed in such a manner that the user can select the input of the mark position, the color of the mark, and the pattern of the mark or can select either a mode in which the pages to which the mark is added are all pages or a mode in which they are the designated pages in such a manner that they can be displayed on the UI display screen which is displayed to the operation display apparatus 400. Thus, the user can set area attributes including the color and pattern of the area where the mark should be added. Further, the user can set the area attributes, on a page unit basis, including the color and pattern of the area where the mark should be added. In addition, the area where the mark should be added can be also set by obtaining characteristics information of the cutting unit for cutting the sheet sheaf. Moreover, it is also possible to construct in such a manner that the area where the mark should be added, the color, and the pattern can be also set in accordance with a residual quantity of a developer which is used by the image forming apparatus 10 as a printing unit.

As for the cutting mark including a permission range as mentioned above, the user can also designate such a permission range on the cutting mark setting display screen as illustrated in FIG. 19B. FIG. 19B is a diagram illustrating the setting display screen of the cutting mark in the third embodiment. In the setting display screen of FIG. 19B, from the cutting position, the user designates the values of the range (x2, y2) where the cutting mark is not added and the range (x3, y3) where the cutting mark is added. The color and pattern of the mark can be selected for the range (x3, y3) where the cutting mark is added.

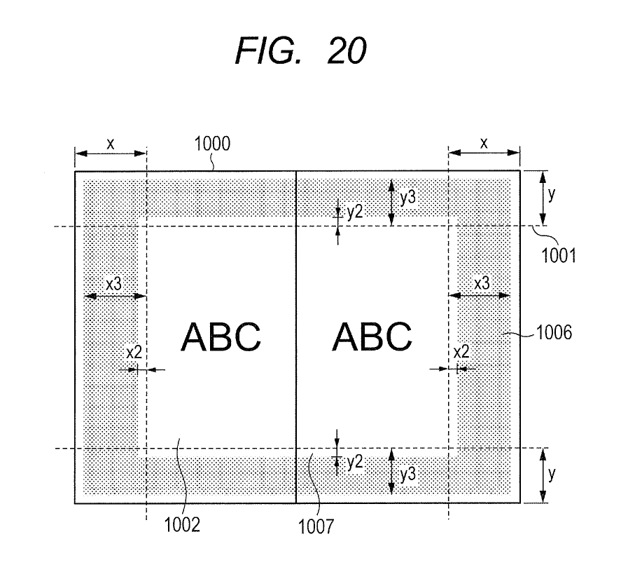

FIG. 20 is a diagram illustrating an example of a print image to which the cutting mark including the permission range of the misregistration has been added on the setting display screen illustrated in FIG. 19B.

In FIG. 20, in a manner similar to FIG. 19A, the cutting mark is not added to the permission range 1007 on the outside from the range 1002 of the paper after the cutting but the cutting mark is added to the range 1006 of (x2, y2) to the cutting position 1001 from such a range. The permission range where the cutting mark is not added is decided on the basis of the values of x2 and y2 which were designated by the user in FIG. 19B.

As mentioned above, by adding the cutting mark including the permission range of the misregistration, since the marker is not added to the range where the user can permit in the misregistration of the bookbinding product, the bookbinding product in which only the misregistration out of the permission range can be formed.

### Other Embodiments

As another embodiment of the invention, the setting methods of the cutting mark shown in the embodiments 1 to 3 can be also combined and used. By this method, since the cutting mark according to the engine performance which the image forming apparatus 10 has or the favorite inspecting level of the user can be set, it is more effective for the improvement of the precision of the bookbinding product inspection by the visual inspection confirmation or for the reduction of the load of the inspector.

The invention can be also realized by a method whereby software (application) having the functions of the embodiment mentioned above is implemented into the computer 210, the bookbinding setting including the cutting mark information is transmitted to the image forming apparatus 10 through the external I/F 209, and a similar bookbinding process is executed. At this time, the processes such as creation of the print image and the like based on the various kinds of settings regarding the bookbinding mode and the cutting mode in the operation display apparatus 400 in the foregoing embodiments and the various kinds of settings in the image signal controlling unit 202 is substituted by software on the computer 210.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or an apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-262270, filed Nov. 30, 2011, which is hereby incorporated by reference herein in its entirety.

What is claimed is:

1. An image forming apparatus comprising:
an obtaining unit configured to obtain image data which is printed onto a sheet;
a first setting unit configured to set whether or not a cutting process for cutting the sheet is executed; and
a printing unit configured to execute the printing on the basis of the image data in the case where it is set by the first setting unit that the cutting process is executed and print a mark to an outer circumferential side of the sheet by using a cutting position, as a reference, where the cutting process is executed.

2. The apparatus according to claim 1, further comprising a second setting unit configured to set a size of the mark, and
wherein the printing unit prints the mark of the size set by the second setting unit onto the outer circumferential side of the sheet from the cutting position.

3. The apparatus according to claim 2, wherein the second setting unit further sets a size of an area where the mark is not printed to the outer circumferential side of the sheet from the cutting position.

4. The apparatus according to claim 1, further comprising a third setting unit configured to set a kind of the mark.

5. The apparatus according to claim 4, wherein the kind of the mark includes a color and a pattern of the mark.

6. The apparatus according to claim 1, further comprising a cutting unit configured to execute the cutting process.

7. The apparatus according to claim 1, wherein in the case where it is set by the first setting unit that the cutting process is not executed, the printing unit does not print the mark of a predetermined size but executes the printing on the basis of the image data.

8. The apparatus according to claim 1, further comprising a forming unit configured to form print data for printing the image data and the mark of a predetermined size, and
wherein in the case where it is set by the first setting unit that the cutting process is executed, the printing unit executes the printing on the basis of the print data.

9. An image forming system comprising:
an obtaining unit configured to obtain image data which is printed onto a sheet;
a first setting unit configured to set whether or not a cutting process for cutting the sheet is executed; and
a printing unit configured to execute the printing on the basis of the image data in the case where it is set by the first setting unit that the cutting process is executed and print a mark to an outer circumferential side of the sheet by using a cutting position, as a reference, where the cutting process is executed.

10. The system according to claim 9, further comprising a cutting unit configured to execute the cutting process.

11. A controlling method of an image forming apparatus, comprising:
an obtaining step of obtaining image data which is printed onto a sheet;
a setting step of setting whether or not a cutting process for cutting the sheet is executed; and
a printing step of executing the printing on the basis of the image data in the case where it is set in the setting step that the cutting process is executed and printing a mark to an outer circumferential side of the sheet by using a cutting position, as a reference, where the cutting process is executed.

12. A storage medium which stores a program for allowing a computer to execute the controlling method of the image forming apparatus according to claim 11.
